(19) United States
(12) Patent Application Publication
(10) Pub. No.: US 2005/0031958 A1
(43) Pub. Date: Feb. 10, 2005

(54) Lithium ion secondary battery negative electrode material and its preparation

(76) Inventors: Hirofumi Fukuoka, Usui-gun (JP); Mikio Aramata, Usui-gun (JP); Kazuma Momii, Tokyo (JP); Satoru Miyawaki, Usui-gun (JP)

Correspondence Address: BIRCH STEWART KOLASCH & BIRCH, PO BOX 747, FALLS CHURCH, VA, 22040-0747, US

(21) Appl. No.: 10/910,317

(22) Filed: Aug. 4, 2004

(30) Foreign Application Priority Data
Aug. 5, 2003 (JP) 2003-286888

(51) Int. Cl. H01M 4/58; H01M 4/62; B05D 5/12

(52) U.S. Cl. 429/218.1; 429/232; 427/122; 429/231.95

(57) ABSTRACT

A metallic silicon-containing composite in which metallic silicon nuclei are coated with an inert material which does not contribute to adsorption and desorption of lithium ions is a useful negative electrode material for lithium ion secondary batteries. Using the composite as a negative electrode active material, a lithium ion secondary battery having a high capacity and excellent cycle performance can be fabricated.

### TECHNICAL FIELD

This invention relates to a lithium ion secondary battery negative electrode material having a high charge/discharge capacity and satisfactory cycle performance when used as the negative electrode active material, and a method for preparing the same.

### BACKGROUND ART

As portable electronic equipment and communication tools are currently brought under rapid development, a strong desire for a secondary battery having a high energy density arises from the standpoints of economy and size and weight reductions. Prior art approaches for increased capacities of secondary batteries include a negative electrode comprising Si powder, a conductive agent and a binder (see Japanese Patent No. 3,008,269), a negative electrode material comprising oxides of V, Si, B, Zr, Sn or the like and complex oxides thereof (see JP-A 5-174818 and JP-A 6-60867 corresponding to U.S. Pat. No. 5,478,671), a negative electrode material obtained by quenching a melt of metal oxide (see JP-A 10-294112), a negative electrode material comprising silicon oxide (see Japanese Patent No. 2,997,741 corresponding to U.S. Pat. No. 5,395,711), and a negative electrode material comprising Si₂N₂O and Ge₂N₂O (see JP-A 11-102705 corresponding to U.S. Pat. No. 6,066,414). For imparting electric conductivity to negative electrode materials, JP-A 2000-243396 corresponding to U.S. Pat. No. 6,638,662 discloses mechanical alloying of SiO with graphite, followed by carbonization, and JP-A 2000-215887 corresponding to U.S. Pat. No. 6,383,686 discloses surface coating of Si particles with a carbon layer by chemical vapor deposition.

These prior art approaches are not always satisfactory in that the charge/discharge capacity and energy density are increased, but not to a full extent to meet the commercial requirements, and the cycle performance is insufficient. A further improvement in energy density is also demanded.

In particular, Japanese Patent No. 3,008,269 describes a high capacity battery using silicon as the negative electrode constituting material. In Examples, no reference is made to cycle performance. As long as the inventors have empirically confirmed, the cycle performance of this battery is poor, far below the practically acceptable level of lithium ion secondary battery. JP-A 2000-215887 relates to the technology of improving silicon which is theoretically expected as a high capacity negative electrode material. Silicon used as the negative electrode material undergoes excessive expansion and shrinkage upon adsorption and desorption of lithium ions. As the consequence, the battery does not perform at a practical level in that the cycle performance is lost or a certain limit must be imposed on the charge/discharge quantity to prevent a lowering of cycle performance.

As used herein, the term “conductivity” refers to electric conductivity.

### SUMMARY OF THE INVENTION

An object of the present invention is to provide a negative electrode material for lithium ion secondary batteries having a high capacity and a minimized loss of cycle performance and offering a practically acceptable level of operation, and a method for preparing the same.

Paying attention to metallic silicon which is theoretically expected as a high capacity negative electrode material, the inventors investigated the mechanism of degradation of metallic silicon by cyclic operation. When metallic silicon, a negative electrode material capable of substantial occlusion and release of lithium ions is used, the electrode undergoes substantial expansion and shrinkage upon adsorption and desorption of lithium ions. As a result, the negative electrode material is disintegrated and powered so that the conduction network is broken. This is a cause of cycle performance lowering. Then, the inventors attempted to develop a negative electrode material which is prevented from disintegration and powdering and maintains a high conductivity even after repeated cycles. As a result, the inventors have discovered that a metallic silicon-containing composite in which an inert material which does not contribute to adsorption and desorption of lithium ions is formed on surfaces of metallic silicon is used as a matrix to maintain strength, and that the surface of the metallic silicon-containing composite is further covered with a conductive coating to maintain a high conductivity. As a result, even after repeated expansion and shrinkage due to charge/discharge operations, the negative electrode material is prevented from disintegration and powdering and the conductivity of the electrode itself is kept unchanged. The use of this negative electrode material enables fabrication of a lithium ion secondary battery which is improved in cycle performance.

In a first aspect, the invention provides a lithium ion secondary battery negative electrode material comprising a metallic silicon-containing composite having metallic silicon as nuclei coated with an inert material which does not contribute to adsorption and desorption of lithium ions.

The inert material is preferably silicon dioxide, silicon carbide, silicon nitride or silicon oxynitride. The content of the inert material is preferably 1 to 70% by weight of the metallic silicon-containing composite.

In a preferred embodiment, the metallic silicon-containing composite is further surface covered with a conductive coating, which is typically a carbon coating.

In a second aspect, the invention provides a method for preparing a lithium ion secondary battery negative electrode material, comprising the step of coating surfaces of metallic silicon particles with an inert material which does not contribute to adsorption and desorption of lithium ions.

The invention also provides a method for preparing a lithium ion secondary battery negative electrode material, comprising the steps of coating surfaces of metallic silicon particles with an inert material which does not contribute to adsorption and desorption of lithium ions, to thereby form a metallic silicon-containing composite, and heat treating the metallic silicon-containing composite in an atmosphere containing at least an organic material gas or vapor and at a temperature in the range of 500 to 1,300° C. for thereby covering the surface of the composite with a carbon coating.

Using the metallic silicon-containing composite of the invention as a negative electrode active material, a lithium ion secondary battery having a high capacity and excellent cycle performance can be fabricated. The resulting lithium ion secondary battery fully satisfies the market requirements. The preparation method is simple and effective and allows for an industrial scale of manufacture.

### DESCRIPTION OF THE PREFERRED EMBODIMENTS

The lithium ion secondary battery negative electrode material of the invention is in the form of a metallic silicon-containing composite in which metallic silicon as nuclei is coated with an inert material which does not contribute to adsorption and desorption of lithium ions. Preferably the composite is further surface covered with a conductive coating.

The metallic silicon used herein is not particularly limited and may be selected from those of the grades for semiconductor, ceramic and silicone uses. Most often, the metallic silicon used is finely divided to a predetermined particle size by pulverizing in a ball mill, jet mill or customary grinding mill. The particle size as pulverized is not particularly limited, although an average particle size of 0.5 to 50 μm, especially 0.8 to 30 μm is preferred. An average particle size of less than 0.5 μm may need a more amount of binder used in electrode formation, leading to a lowering of battery capacity. An average particle size of more than 50 μm may make it difficult to form an electrode.

The present invention is characterized by the use as a matrix of a metallic silicon-containing composite comprising metallic silicon and an inert material which does not contribute to adsorption and desorption of lithium ions. The inert material which does not contribute to adsorption and desorption of lithium ions is not particularly limited. Examples of the inert material include oxides (such as silicon dioxide), nitrides, oxynitrides, and carbides of metallic silicon, and metals such as Ti, Mn, Fe, Co, Ni, Cu, Ta and W, and silicon alloys thereof. For ease of formation, oxides (such as silicon dioxide), nitrides, oxynitrides, and carbides of metallic silicon are preferred. Specific compounds include silicon dioxide, silicon oxynitride, silicon carbide, and silicon nitride.

The state of the inert material which does not contribute to adsorption and desorption of lithium ions is not particularly limited as well. The inert material dispersed in metallic silicon can exert a desired effect although the inert material overlying surfaces of metallic silicon exerts a more desired effect.

The proportion of the inert material in the metallic silicon-containing composite is preferably 1 to 70% by weight, more preferably 2 to 50% by weight. Less than 1 wt % of the inert material may be insufficient to prevent disintegration and powdering of the negative electrode material by expansion and shrinkage of the electrode during charging/discharging operations, resulting in a loss of cycle performance. More than 70 wt % of the inert material apparently improves the cycle performance, but may lower the battery capacity due to a reduced proportion of metallic silicon.

In the practice of the invention, battery characteristics can be more improved by further coating the surface of the metallic silicon-containing composite with a conductive coating. The conductive coating may be made of a conductive material which does not degrade or alter in the resulting battery. Examples include coatings of metals such as Al, Ti, Fe, Ni, Cu, Zn, Ag and Sn, and carbon. Of these, the carbon coating is preferred for ease of deposition and a high conductivity.

The coating weight or buildup of the conductive coating is preferably 5 to 70% by weight, more preferably 10 to 50% by weight based on the overall weight of the conductive coating-covered metallic silicon-containing composite (that is, metallic silicon-containing composite plus conductive coating). A buildup of less than 5 wt % may be insufficient for the conductive coating to exert its own effect. A buildup of more than 70 wt % corresponds to a reduced proportion of metallic silicon relative to the overall weight, sometimes resulting in a battery with a reduced capacity.

Next, the preparation of the lithium ion secondary battery negative electrode material is described.

The lithium ion secondary battery negative electrode material can be prepared by converting part of metallic silicon into an inert material which does not contribute to adsorption and desorption of lithium ions, to thereby form a metallic silicon-containing composite. More specifically, it can be prepared by partial oxidation, nitriding, oxynitriding or carbonization of metallic silicon. In the case of partial oxidation, for example, metallic silicon is held in an oxygen-containing atmosphere, typically air at a temperature in the range of 700 to 1,300° C. for about 30 minutes to about 10 hours. In the case of partial nitriding, metallic silicon is similarly heat treated in a nitrogen atmosphere. For oxynitriding, the process may resort to heat treatment in the presence of oxygen and nitrogen.

When it is desired to coat the surface of the metallic silicon-containing composite with a conductive carbon coating, the metallic silicon-containing composite is heat treated in an atmosphere containing at least an organic material gas or vapor and at a temperature in the range of 500 to 1,300° C., preferably 700 to 1,200° C. for thereby forming a carbon coating that covers the surface of the composite. Heat treatment below 500° C. may fail to form a conductive carbon coating or must be continued for a longer time, resulting in inefficiency. A temperature above 1,300° C. has a possibility that particles are fused and agglomerated together by chemical vapor deposition, thus failing to form a conductive coating at the agglomerated faces, resulting in a lithium ion secondary battery negative electrode material with a poor cycle performance.

Where silicon carbide is coated on surfaces of metallic silicon as the inert material which does not contribute to adsorption and desorption of lithium ions, this step may be conducted at the same time as the carbon coating treatment. In this embodiment, heat treatment may be carried out preferably at a temperature of 1,100 to 1,300° C., more preferably 1,150 to 1,250° C. At a treating temperature below 1,100° C., silicon carbide may not form. A treating temperature above 1,300° C. has a possibility that particles are fused and agglomerated together by chemical vapor deposition, thus failing to form a conductive coating at the agglomerated faces, resulting in a lithium ion secondary battery negative electrode material with a poor cycle performance.

The organic material from which the organic gas is generated is preferably selected from those which pylolyze in a non-oxidizing atmosphere at the above-described heat treatment temperature to form carbon (or graphite), for example, hydrocarbons such as methane, ethane, ethylene, acetylene, propane, butane, butene, pentane, isobutane, and hexane, alone or in admixture; and mono- to tri-cyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene, alone or in admixture. Also included are gas oil resulting from the tar distillation step, creosote oil, anthracene oil, and naphtha cracked tar oil, alone or in admixture.

The heat treatment of the metallic silicon-containing composite in the organic gas may be carried out using a reactor having a heating unit in a non-oxidizing atmosphere. The heat treatment may be done either continuously or batchwise. Specifically, depending on a particular purpose, a proper reactor may be chosen from among a fluidized bed reactor, rotary kiln, vertical moving bed reactor, tunnel furnace, batch furnace and the like.

The amount of carbon deposited is preferably 5 to 70% by weight, more preferably 10 to 50% by weight based on the overall weight of the metallic silicon-containing composite having carbon deposited thereon. A carbon deposition amount of less than 5 wt % may fail to achieve a significant improvement in conductivity, resulting in a lithium ion secondary battery negative electrode material with a poor cycle performance. An amount of more than 70 wt % indicates a too much proportion of carbon, sometimes resulting in a lithium ion secondary battery negative electrode material with a reduced negative electrode capacity.

Using the metallic silicon-containing composite of the invention, a lithium ion secondary battery can be fabricated. The lithium ion secondary battery thus fabricated is characterized by the use of the above-specified negative electrode material as a negative electrode active material while no limits are imposed on the remaining components including the materials of positive electrode, negative electrode, electrolyte, separator and the like and the battery configuration. For example, the positive electrode active materials which can be used include transition metal oxides and chalcogenides such as LiCoO₂, LiNiO₂, LiMn₂O₄, V₂O₆, MnO₂, TiS₂ and MOS₂. The electrolytes which can be used include non-aqueous solutions of lithium salts such as lithium perchlorite, and the non-aqueous solvent may be propylene carbonate, ethylene carbonate, dimethoxyethane, γ-butyrolactone or 2-methyltetrahydrofuran alone or in combination of any. Various other non-aqueous electrolytes and solid electrolytes are also useful.

It is understood that in the preparation of a negative electrode using the lithium ion secondary battery negative electrode material of the invention, a conductive agent such as graphite may be added to the negative electrode material. The type of conductive agent is not particularly limited, and any electron conductive material which does not degrade or alter in the completed battery may be used. Examples include powder and fiber forms of metals such as Al, Ti, Fe, Ni, Cu, Zn, Ag, Sn, and Si, natural graphite, artificial graphite, various coke powders, meso-phase carbon, vapor phase grown carbon fibers, pitch-derived carbon fibers, PAN-derived carbon fibers, and graphites obtained by firing various resins.

### EXAMPLE

Examples and comparative examples are given below for illustrating the present invention although the invention is not limited thereto.

### Example 1

An alumina crucible was charged with 100 g of a metallic silicon powder having an average particle size of 5 μm and placed in an air furnace where surface oxidative treatment was conducted at 800° C. for 3 hours. The oxidized product was a metallic silicon-containing composite having an oxygen content of 13 wt % and surface coated with silicon dioxide.

Battery Evaluation:

A battery was fabricated using the metallic silicon-containing composite as a negative electrode active material. The operation of the battery was evaluated as follows.

Artificial graphite having an average particle size of 5 μm was added to the metallic silicon-containing composite to form a mixture having a carbon proportion of 40 wt %. To the mixture, 10 wt % of polyvinylidene fluoride was added, and N-methylpyrrolidone was then added to form a slurry. The slurry was coated onto a copper foil of 20 μm thick and dried at 120° C. for one hour. The coated foil was pressure formed by a roller press and finally punched into a disk or negative electrode having a diameter of 20 mm.

To evaluate the charge/discharge characteristics of this negative electrode, a lithium ion secondary battery for assay was constructed by using a lithium foil as the counter electrode, a non-aqueous electrolyte solution of lithium hexafluorophosphate in a 1/1 (volume ratio) mixture of ethylene carbonate and 1,2-dimethoxyethane in a concentration of 1 mol/liter as the non-aqueous electrolyte, and a porous polyethylene film of 30 μm thick as the separator.

The lithium ion secondary battery thus constructed was allowed to stand at room temperature overnight. Using a secondary battery charge/discharge tester (by Nagano Co., Ltd.), charging was conducted at a constant current of 1 mA until the voltage of the test cell reached 0 volt, and after 0 volt was reached, charging was conducted at a reduced current such that the cell voltage was kept at 0 volt. At the point when the current value decreased below 20 μA, the charging was terminated. Discharging was conducted at a constant current of 1 mA and at the point when the cell voltage increased beyond 1.8 volts, the discharging was terminated. A discharge capacity was determined.

The charge/discharge cycle was repeated to accomplish a 100 cycle charge/discharge test on the lithium ion secondary battery for assay. The lithium ion secondary battery had a 1st cycle discharge capacity of 1463 mAh/g, a 100th cycle discharge capacity of 1094 mAh/g, a capacity retentivity after 100 cycles of 75%, indicating a high capacity and excellent cycle performance.

### Example 2

An alumina crucible was charged with 100 g of the metallic silicon-containing composite obtained in Example 1 and placed in a controlled atmosphere furnace. In a stream of Ar gas at a rate of 2.0 NL/min, the crucible was heated at a heat rate of 300° C./hr to a temperature of 1,100° C. and held thereat. After the temperature of 1,100° C. was reached, CH₄ gas was additionally flowed at a rate of 2.0 NL/min. In this state, chemical vapor deposition was conducted for 3 hours. At the end of the run, the furnace was cooled down whereupon a black powder was recovered. This black powder was a conductive coating-covered, metallic silicon-containing composite having a graphite buildup of 22.5 wt % based on the overall weight of the metallic silicon-containing composite after the vapor deposition.

As in Example 1, a lithium ion secondary battery was fabricated using the conductive coating-covered, metallic silicon-containing composite. The battery was assayed as in Example 1. The lithium ion secondary battery had a 1st cycle discharge capacity of 1078 mAh/g, a 100th cycle discharge capacity of 1022 mAh/g, a capacity retentivity after 100 cycles of 95%, indicating a high capacity and excellent cycle performance.

### Example 3

An alumina crucible was charged with 100 g of a metallic silicon powder having an average particle size of 5 μm as used in Example 1 and placed in a controlled atmosphere furnace. While a gas mixture of N₂+20% H₂ was fed at a flow rate of 3 NL/min, surface nitriding treatment was conducted at 1200° C. for 5 hours. The nitrided product was a metallic silicon-containing composite having a nitrogen content of 18 wt % and surface coated with silicon nitride.

Chemical vapor deposition was carried out on the silicon nitride-coated metallic silicon-containing composite as in Example 2, obtaining a conductive coating-covered, metallic silicon-containing composite having a graphite buildup of 21.0 wt %.

As in Example 1, a lithium ion secondary battery was fabricated using this conductive coating-covered, metallic silicon-containing composite. The battery was assayed as in Example 1. The lithium ion secondary battery had a 1st cycle discharge capacity of 1612 mAh/g, a 100th cycle discharge capacity of 1492 mAh/g, a capacity retentivity after 100 cycles of 93%, indicating a high capacity and excellent cycle performance.

### Example 4

An alumina crucible was charged with 100 g of a metallic silicon powder having an average particle size of 5 μm as used in Example 1 and placed in a controlled atmosphere furnace. While a gas mixture of Ar+50% CH₄ was fed at a flow rate of 3 NL/min, surface carbonizing treatment and chemical vapor deposition were simultaneously conducted at 1250° C. for 5 hours. The product was a conductive coating-covered, metallic silicon-containing composite having a silicon carbide content of 28 wt % and a graphite buildup of 24.3 wt %.

As in Example 1, a lithium ion secondary battery was fabricated using this conductive coating-covered, metallic silicon-containing composite. The battery was assayed as in Example 1. The lithium ion secondary battery had a 1st cycle discharge capacity of 1193 mAh/g, a 100th cycle discharge capacity of 1147 mAh/g, a capacity retentivity after 100 cycles of 96%, indicating a high capacity and excellent cycle performance.

### Comparative Example

Using an untreated metallic silicon powder (as used in Example 1) as the negative electrode material, a lithium ion secondary battery was fabricated as in Example 1. The battery was assayed as in Example 1. The lithium ion secondary battery had a 1st cycle discharge capacity of 2340 mAh/g, a 100th cycle discharge capacity of 748 mAh/g, a capacity retentivity after 100 cycles of 32%, indicating a high capacity, but very poor cycle performance.

Japanese Patent Application No. 2003-286888 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A lithium ion secondary battery negative electrode material comprising a metallic silicon-containing composite having metallic silicon as nuclei coated with an inert material which does not contribute to adsorption and desorption of lithium ions.

2. The lithium ion secondary battery negative electrode material of claim 1, wherein said metallic silicon-containing composite is further surface covered with a conductive coating.

3. The lithium ion secondary battery negative electrode material of claim 2, wherein the conductive coating is a carbon coating.

4. The lithium ion secondary battery negative electrode material of claim 1, wherein said inert material is silicon dioxide, silicon carbide, silicon nitride or silicon oxynitride.

5. The lithium ion secondary battery negative electrode material of claim 1, wherein said metallic silicon-containing composite contains 1 to 70% by weight of said inert material.

6. A method for preparing a lithium ion secondary battery negative electrode material, comprising the step of coating surfaces of metallic silicon particles with an inert material which does not contribute to adsorption and desorption of lithium ions.

7. A method for preparing a lithium ion secondary battery negative electrode material, comprising the steps of:
coating surfaces of metallic silicon particles with an inert material which does not contribute to adsorption and desorption of lithium ions, to thereby form a metallic silicon-containing composite, and
heat treating the metallic silicon-containing composite in an atmosphere containing at least an organic material gas or vapor and at a temperature in the range of 500 to 1,300° C. for thereby covering the surface of the composite with a carbon coating.
